(19) United States
(12) Patent Application Publication
(10) Pub. No.: US 2020/0224980 A1
(43) Pub. Date: Jul. 16, 2020

(54) COLD GAS WELDING OF BRACKETS TO ALUMINUM HEAT EXCHANGERS

(71) Applicant: Hanon Systems, Daejeon (KR)

(72) Inventors: Richard Armsden, Billericay (GB); David Bowring, Maldon (GB); Nigel Seeds, Braintree (GB)

(21) Appl. No.: 16/249,254

(22) Filed: Jan. 16, 2019

(51) Int. Cl. F28F 9/007; B23K 1/00; B60H 1/00; B21D 53/08; F28F 9/02

(52) U.S. Cl. CPC F28F 9/0075; B23K 1/0012; F28F 2275/045; B21D 53/08; F28F 9/02; B60H 1/00328

(57) ABSTRACT

A heat exchanger for a vehicle includes a heat exchanger core. The heat exchanger core is configured to exchange heat between fluids. The heat exchanger further includes a header. The header is in fluid communication with the heat exchanger. A bracket is coupled to the header by a cold forming process.

### FIELD OF INVENTION

This disclosure relates generally to brackets attached to a heat exchanger core and more particularly to a system and method of attaching plastic brackets to a heat exchanger core after a heat exchanger core brazing process.

### FIELD OF INVENTION

As known, heat exchangers are employed to cool fluids flowing through the vehicle. Examples of heat exchangers include condensers and radiators. Components of the heat exchangers include a heat exchanger core configured to exchange heat between fluids or materials and a header coupled to and in communication with the core. Conduits are coupled to the headers to convey fluids to the headers. Many of the components of the heat exchanger are formed from a metal such as aluminum and are assembled together by a brazing process.

The heat exchangers are commonly mounted to the vehicle body structure or other components of the vehicle, directly or indirectly, by a bracket. Typically, the bracket is coupled to the heat exchangers before or during the brazing of the heat exchanger. The bracket is coupled to the heat exchanger such as to the headers. Further, the bracket can be reinforced to or separately connected to the heat exchanger by rivets or fasteners.

However, the current bracket structures and methods of coupling the bracket can be disadvantageous. Particularly, it may be desired to increase a complexity, strength, and functionality of the bracket depending on the space and structure available to mount the heat exchanger to the vehicle. However, an increase in complexity, strength, and functionality the bracket may undesirably increase a weight and a cost of the heat exchanger when demand requires minimized weight and cost of the heat exchanger. Additionally, a hole is typically required in the heat exchanger for the rivet or fastener of the bracket when the bracket is coupled to the heat exchanger by rivets or fasteners. The hole is susceptible to leaking. Furthermore, it is often desired to minimize a package size of the heat exchanger due to limited space requirements. Minimizing the package size of the heat exchanger can be difficult to accomplish with current brackets and methods of coupling the brackets to the heat exchangers.

Therefore, it is desired to have a bracket and method of coupling the bracket to the heat exchanger after a brazing process of the heat exchanger, wherein the bracket minimizes leakage, a cost, a weight, and a package size of the heat exchanger while maximizing complexity, strength, and functionality of the bracket.

### SUMMARY

In accordance and attuned with the present invention, a plastic bracket and method of coupling the bracket to the heat exchanger that minimizes leakage, a cost, a weight, and a package size of the heat exchanger while maximizing complexity, strength, and functionality of the bracket has surprisingly been discovered.

According to an embodiment of the disclosure, a heat exchanger for a vehicle includes a heat exchanger core. The heat exchanger core is configured to exchange heat between fluids. The heat exchanger further includes a header. The header is in fluid communication with the heat exchanger. A bracket is coupled to the header by a cold forming process.

According to another embodiment of the disclosure, a heat exchanger for a vehicle includes a heat exchanger core and header assembly configured to exchange heat between fluids. The heat exchanger core and header assembly includes an outer surface. A bracket is coupled to the outer surface of the heat exchanger core and header assembly by a cold forming process. A weld joint is formed between the bracket and the outer surface of the heat exchanger core and header assembly by the cold forming process.

According to yet another embodiment of the disclosure, a method of assembling a heat exchanger and a bracket is disclosed. The method includes the step of assembling a heat exchanger core and a header to the heat exchanger core by a first process. The method additionally includes the step of coupling a bracket to an outer surface of the assembled heat exchanger core and the header by a second process after the first process, wherein the second process is a cold forming process.

### BRIEF DESCRIPTION OF THE DRAWINGS

The above objects and advantages of the invention, as well as others, will become readily apparent to those skilled in the art from reading the following detailed description of an embodiment of the invention when considered in the light of the accompanying drawings, in which:

FIG. 1 is a side perspective view of a heat exchanger according to an embodiment of the disclosure;

FIG. 2 is an enlarged fragmentary left side perspective view of a bracket coupled to a heat exchanger according to an embodiment of the disclosure;

FIG. 3 is an enlarged fragmentary left side perspective view of a bracket coupled to a heat exchanger according to another embodiment of the disclosure;

FIG. 4 is an enlarged fragmentary left side perspective view of a bracket coupled to a heat exchanger according to another embodiment of the disclosure;

FIG. 5 is an enlarged fragmentary left side perspective view of a bracket coupled to a heat exchanger according to another embodiment of the disclosure;

FIG. 6 is an enlarged fragmentary left side perspective view of a bracket coupled to a heat exchanger according to another embodiment of the disclosure;

FIG. 7 is an enlarged fragmentary right side perspective view of a bracket coupled to a heat exchanger according to another embodiment of the disclosure;

FIG. 8 is an enlarged fragmentary right side perspective view of a bracket coupled to a heat exchanger according to another embodiment of the disclosure;

FIG. 9 is an enlarged fragmentary left side perspective view of a bracket coupled to a heat exchanger according to another embodiment of the disclosure; and

FIG. 10 is a flow diagram illustrating a method of coupling a bracket to a heat exchanger.

### DETAILED DESCRIPTION OF THE EMBODIMENTS

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical unless otherwise noted.

A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

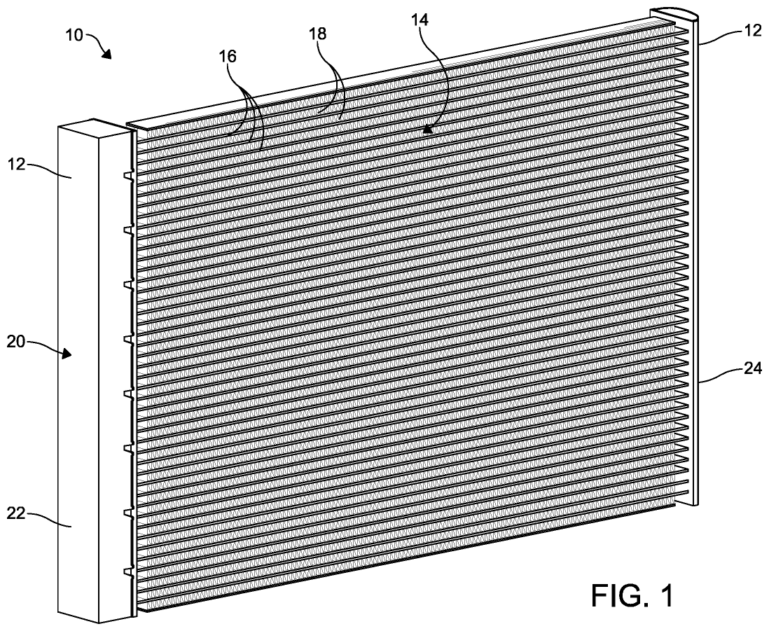

FIG. 1 illustrates a heat exchanger 10 of vehicle according to an embodiment of the invention. The heat exchanger 10 is configured to be a component of an engine cooling system a motor vehicle (not shown) such as a radiator, for example. However, the heat exchanger 10 can be configured as a component of a refrigeration system of the vehicle such as a condenser or evaporator, for example. It is understood that the heat exchanger 10 could be used in other systems employing heat exchangers as desired.

The heat exchanger 10 includes a pair of tanks or headers 12 and a heat exchanger core 14. The tanks 12 are elongated conduits arranged in a substantially parallel relationship to each other. The tanks 12 convey a flow of fluid such as an inlet flow of fluid and outlet flow of fluid. The fluid can be a fluid configured for heat exchange such as a coolant, refrigerant, water, or any other fluid or material. The tanks 12 can be integrally or separately formed from the heat exchanger core 14. Additionally, the evaporator 10 can have any number of tanks 12 containing the fluid, as desired. The tanks 12 are arranged at opposing ends of the heat exchanger core 14. However, the tanks 12 can be arranged in any order or configuration as desired such as adjacent each other or at other portions of the heat exchanger 10. The tanks 12 are formed from a metal such as aluminum, for example. However, it is understood the tanks 12 can be formed from other materials such as plastic, if desired.

The heat exchanger core 14 is a tube and fin arrangement heat exchanger core. The heat exchanger core 14 includes a plurality of substantially parallel rows of tubes or plates 16 extending from and in fluid communication with the tanks 12. The rows of plates 16 are arranged transversely to the direction of a flow of air through the heat exchanger 10. A plurality of fins 18 are arranged substantially parallel with each other and interposed between the rows of plates 16. The fins 18 are configured to receive the flow of air through the heat exchange core 14.

Other components (not shown) can be included with the heat exchanger 10 such as seals, additional headers or tanks, valves, conduits, gauges or other components commonly included with heat exchangers. The plates 16, the fins 18 and other components are coupled together to form the heat exchanger 10. A brazing process using a clad brazing material that melts under heat to join components together is employed to couple the heat exchange core 14 together and to the tanks 12. However, it is understood other coupling means in addition too or separate from the brazing process can be employed to couple the tanks 12, the heat exchange core 14, and the other components to each other to from the heat exchanger 10.

The heat exchanger 10 has an outer surface 20. The outer surface 20 can have varying surface contours. For example, the tanks 12 can have a generally planar outer surface 22, as illustrated at one of the tanks 12 in FIG. 1, or a generally arcuate outer surface 24, as illustrated at an other one of the tanks 12 of FIG. 1 depending on the types of tanks 12 desired for the heat exchanger 10. It is understood, other portions of the heat exchanger 10 other than the tanks 12 can have varying surface contours such as planar, arcuate, serpentine, rectilinear, or any other contour or combination thereof, as desired.

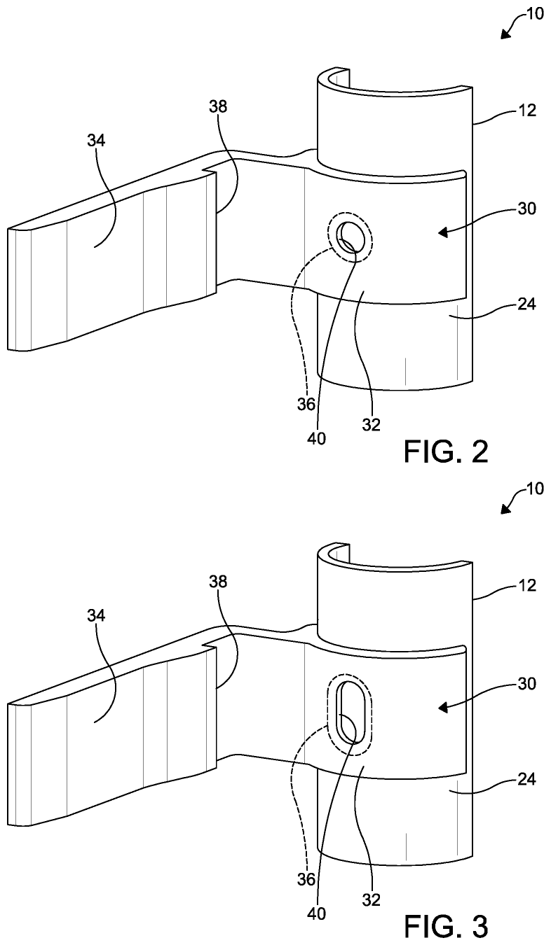

FIGS. 2-9 illustrate examples of a bracket 30 coupled to the heat exchanger 10 according embodiments of the instant disclosure. The bracket 30 shown in FIGS. 2-9 is substantially similar except for varying structural configurations as described herein below. Similar features of the bracket 30 illustrated in FIGS. 2-9 include the same reference numeral for convenience. In one embodiment, the bracket 30 is formed from a plastic material. In another embodiment of the invention, the bracket 30 is formed from metal such as an aluminum, for example. The bracket 30 is coupled to the heat exchanger 10 and is configured to mount the heat exchanger 10, directly or indirectly, to a vehicle structure such as a vehicle frame, a conduit, a tank, a secondary bracket, or other component of the vehicle.

The bracket 30 includes a flange portion 32 for directly engaging the outer surface 20 of the heat exchanger 10 and a structure supporting portion 34 for engaging the vehicle structure. The bracket 30 is coupled to the outer surface 20 of the heat exchanger 10 by a cold gas welding process, described in further detail below with reference to a method of coupling the bracket 30 to the heat exchanger 10. A weld joint 36, schematically represented by the dashed lines, is applied to the bracket 30 and/or the heat exchanger 10 to join the bracket 30 to the heat exchanger 10.

As shown in FIG. 2, the bracket 30 includes an arcuate shaped flange portion 32 for coupling to the tank 12 having the arcuate outer surface 24. The flange portion 32 has an internal radius substantially equal to an external radius of the arcuate outer surface 24. The structure supporting portion 34 extends outwardly from the flange portion 32. In the embodiment illustrated, the structure supporting portion 34 is substantially L-shaped and includes an engagement feature 38 for engaging the vehicle structure. For example, the engagement feature 38 is a tooth for engaging a pawl, shoulder, side, protrusion, or slot of the vehicle structure. An aperture 40 is formed in the flange portion 32. In certain embodiments, the aperture 40 receives fill material for the weld joint 36. The aperture 40 has a substantially circular shape. The weld joint 36 is formed between the bracket 30 and the heat exchanger 10 about an inner edge of the flange portion 32 defining the aperture 40.

As shown in FIG. 3, the bracket 30 is substantially similar to the bracket of FIG. 2 except the aperture 40 has a substantially ovular shape. It should be understood, the aperture 40 can any shape as desired such as a polygonal shape, for example. The weld joint 36 is formed about the inner edge of the flange portion 32 defining the aperture 40.

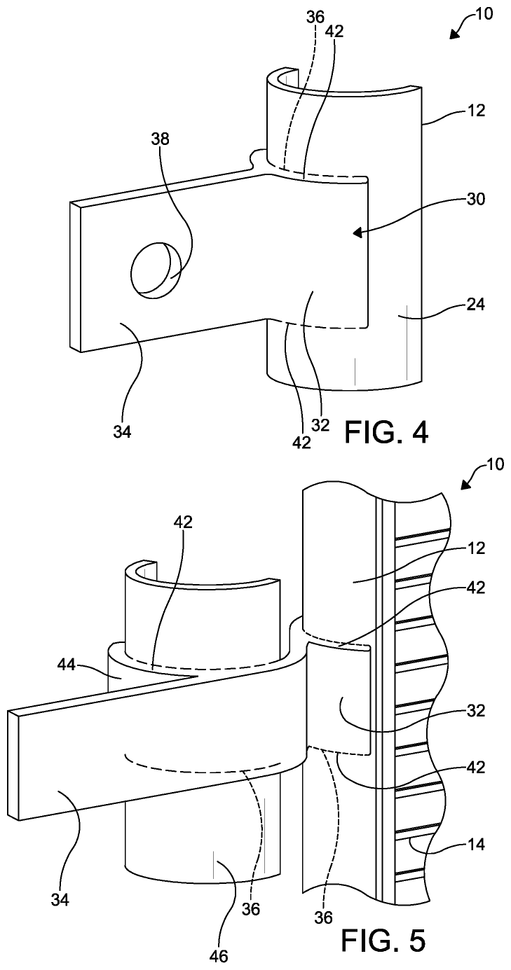

As shown in FIG. 4, the bracket 30 is substantially similar to the brackets 30 of FIGS. 2-3, except the structure supporting portion 34 is a planar plate extending outwardly from the flange portion 32. The engagement feature 38 is a hole formed through the structure supporting portion 34 for receiving a fastener to couple the bracket 30 to the vehicle structure. The weld joint 36 is formed along outer opposing side edges 42 of the flange portion 32. However, it is understood, the weld joint 36 can be formed along an entire outer perimeter of the flange portion 32.

As shown in FIG. 5, the bracket 30 is substantially similar to the bracket 30 of FIG. 4, except the bracket 30 further includes a secondary flange portion 44 for additionally coupling to a secondary component 46. The secondary component 46 can be a conduit or a tank of the vehicle separate from or formed with the heat exchanger 10, for example. In the embodiment illustrated, the secondary flange portion 44 is arcuate to correspond to an arcuate outer surface of the secondary component 46. However, the secondary flange portion 44 can be substantially planar, if desired. The weld joint 36 is applied along the outer opposing side edges 42 of the flange portion 32 and along outer opposing side edges 42 of the secondary flange portion 44. Although, it is understood, the weld joint 36 can be formed along an entire perimeter of the flange portion 32 and the secondary flange portion 44.

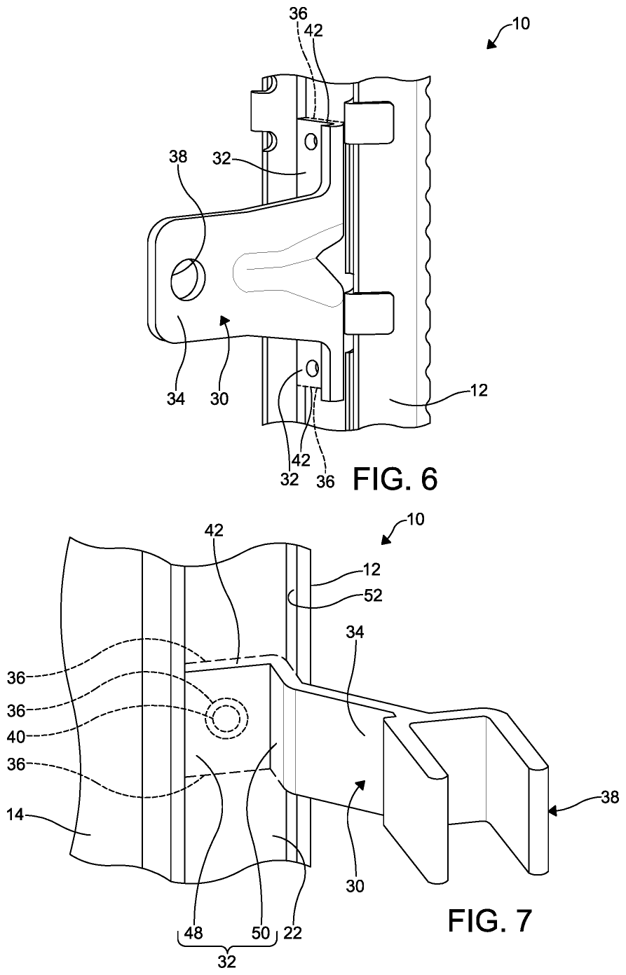

As shown in FIG. 6, the bracket 30 is substantially similar to the bracket 30 of FIG. 4, except the flange portion 32 is substantially planar and is divided into a pair of the flange portions 32 spaced from each other. The flange portion 32 is substantially planar to correspond to the planar outer surface 22 of the tank 12 of the heat exchanger 10. The structure supporting portion 34 is a substantially planar plate extending outwardly from a center portion of the flange portion 32 and includes the engagement feature 38 which is a hole formed therethrough. The weld joint 36 is formed at the outer opposing side edges 42 of the pair of the flange portion 32. However, it is understood, the weld joint 36 can be formed along an entire perimeter of the flange portion 32, if desired.

As shown in FIG. 7, the flange portion 32 of the bracket 30 has a substantially L-shaped cross-section, wherein a first planar leg 48 of the L-shaped flange portion 32 is coupled to the planar outer surface 22 of the tank 12 and a second planar leg 50 of the L-shaped flange portion 32 is coupled to a planar sidewall 52 extending from the planar outer surface 22. The weld joint 36 is formed along the outer opposing side edges 42 of the first planar leg 48 and the second planar leg 50 of the flange portion 32. The weld joint 36 is also formed about the inner edge of the flange portion 32 defining the aperture 40. It is understood, the weld joint 36 can be formed at either outer opposing side edges 42 or about the aperture 40 separately or together. The structure supporting portion 34 is substantially planar and extends outwardly from an end of the second planar leg 50 of the flange portion 32. The engagement feature 38 is formed at a distal end of the structure supporting portion 34 and is a substantially rectilinear brace for receiving the vehicle structure. It is understood the brace can have other shapes as desired depending on the vehicle structure.

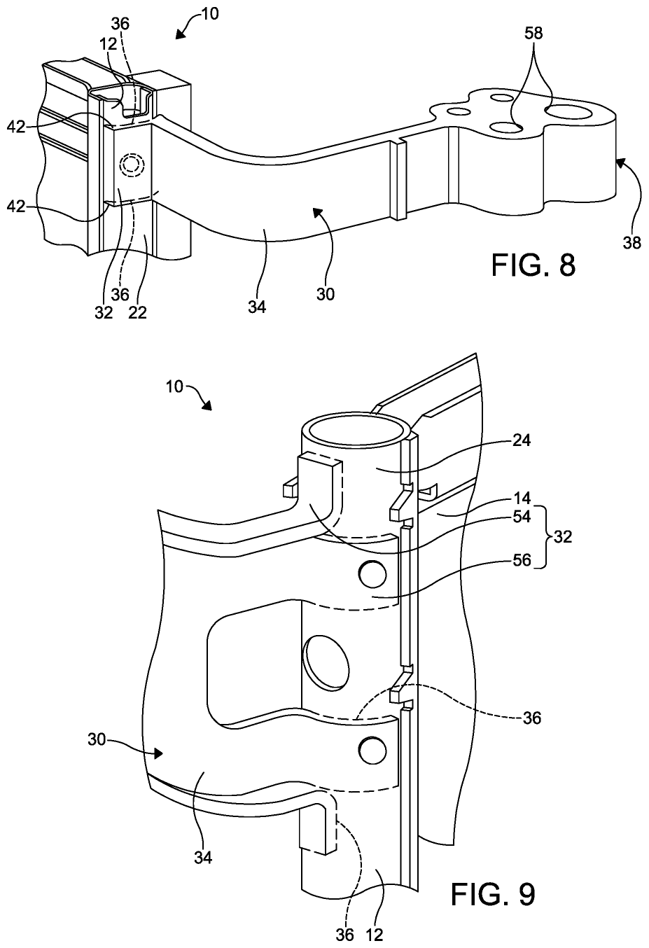

As shown in FIG. 8, the flange portion 32 of the bracket 30 is substantially similar to the arcuate shaped flange portion 32 of FIGS. 2-3. However, the structure supporting portion 34 is different. In the embodiment illustrated, the structure supporting portion 34 is substantially L-shaped and includes the engagement feature 38 for engaging the vehicle structure. In the embodiment illustrated in FIG. 8, the engagement feature 8 is disposed at a distal end of the structure supporting portion 34. The engagement feature 38 is configured as a receptacle with a plurality of holes 58 formed vertically therethrough. The holes 58 are configured to receive conduits or other heat exchanger supporting structures therethrough. The weld joint 36 is applied along the outer opposing side edges 42 of the flange portion 32. Although, it is understood, the weld joint 36 can be formed along an entire perimeter of the flange portion 32. The flange portion 32 includes the aperture 40 with a substantially circular shape. The weld joint 36 can also be formed between the bracket 30 and the heat exchanger 10 about the inner edge of the flange portion 32 defining the aperture 40.

As shown in FIG. 9, the flange portion 32 is coupled to the outer surface 20 of the heat exchanger 10 and is divided into a first pair of flange portions 54 and a second pair of flange portions 56. The first pair of flange portions 54 extends laterally from opposing sides of the structure supporting portion 34 along a longitudinal direction of the tank 12 of the heat exchanger 10. The second pair of flange portions 56 extends from an end of the structure supporting portion 34 of the bracket 30 and is disposed between the first pair of flange portions 54. The structure supporting portion 34 extends outwardly from the flange portions 54, 56 and is configured as an elongate curvilinear member configured to engage the vehicle structure such as a conduit, for example. The weld joint 36 is applied along outer opposing side edges 60 of the second pair of flange portions 56 and along a perimeter of the first pair of flange portions 54. However, it is understood, the weld joint 36 can be applied along an entirety or any portion of the perimeter of each of the first pair of flange portions 54 and the second pair of flange portions 56.

It is understood, the bracket 30 can be any combination of features illustrated in FIGS. 1-9. Additionally, the bracket 30 can be coupled to other portions of the heat exchanger 10 other than the tanks 12 or can be coupled to more than one portion of the heat exchanger 10 as desired. Furthermore, it is understood, the brackets 30 can include one or more configurations and placements of the weld joints 36, as desired. For example, the weld joints 36 can be positioned around an entire perimeter of the flange portions 32, 54, 56 or only portions thereof or about the apertures 40 or within the entire apertures 40.

The bracket 30 is coupled to the heat exchanger 10 at the weld joint 36 by a cold forming process. As used herein a cold forming process is a cold spray process, high pressure cold spray process, or coating deposition method. According to the cold forming process, solid powder particulates of material or fill material are accelerated in a supersonic gas jet to velocities up to 500-1000 meters per second, for example, towards a substrate such as the heat exchanger 10 or the bracket 30, to form the weld joint 36. Although, other velocities can be contemplated. The gas is nitrogen or helium having a pressure greater than 1.5 megapascals (MPa), a flow rate greater than 2 cubic meters per minute, and a heating power greater or equal to 18 kilowatts. The particulates have a diameter in a range of about 1 to 50 micrometers or 5-50 micrometers for high pressure cold spray. The particulates may be formed from materials such as metals, polymers, ceramics, nano-crystalline, or combinations of the same or alternate materials.

During impact of the particulates with the substrate, the particulates undergo plastic deformation and adhere to a surface of the substrate due to expansion of the gas in the gas jet. To achieve a uniform thickness of the particulates on the substrate, a spraying nozzle is employed to direct the particulates along the substrate along a desired path to form the weld joint 36. The kinetic energy of the particulates, supplied to the substrate by the expansion of gas, is converted to plastic deformation energy during bonding of the particulates to the substrate. The cold forming process is different from thermal spraying techniques (e.g. plasma spraying, arc spraying, flame spraying, or high velocity oxygen fuel spraying) because the particulates are not melted during the spraying step of the process.

Advantageously, unlike other additive manufacturing methods and processes such as selective laser melting or electron beam additive manufacturing, the cold forming process does not melt metals or alternate materials. As a result, components and structures formed from metal materials are not affected by heat-related distortion and the parts do not need to be manufactured in an inert gas or vacuum sealed environment. Therefore, larger components and structures that may be formed from materials that are typically difficult to braze or join with other components and structures can be easily joined or brazed with the cold forming process. Advantageously, the cold forming process also permits non-metallic materials to be easily joined to metallic or non-metallic materials easily.

According to the instant disclosure, the bracket 30 can be formed from a plastic material or a metal as desired without concern whether the material the bracket 30 is formed from will deform. With the cold forming process, the bracket 30 is joined to the heat exchanger 10 after the heat exchanger 10 is formed and assembled by a brazing process. A strength and an integrity of the assembled heat exchanger 10 are not compromised by joining the bracket 30 thereto after the heat exchanger 10 is assembled. The joining of the bracket 30 to the assembled heat exchanger 10 after the brazing process of the heat exchanger 10 minimizes distortion of damage to the assembled heat exchanger 10.

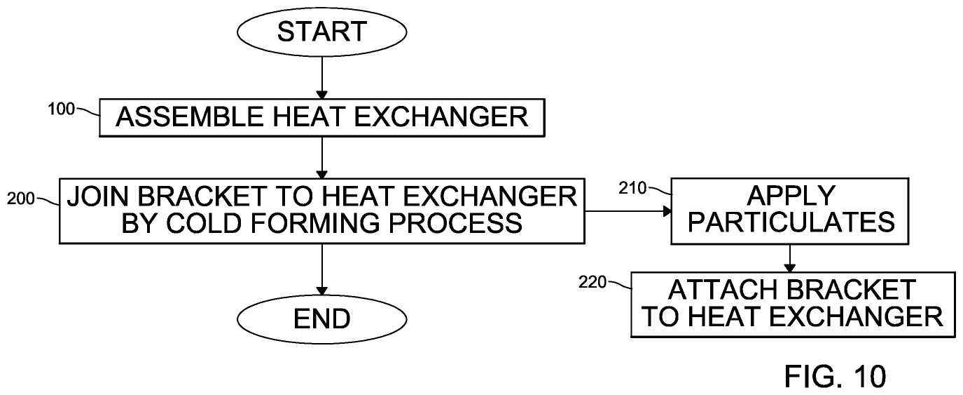

The steps for the assembly of the heat exchanger 10 and the bracket 30 are shown in FIG. 10. In a first step 100, the heat exchanger 10 is assembled. The step of assembling the heat exchanger 10 includes assembly of the headers 12 and the heat exchange core 14 by the brazing process. In a second step 200, the bracket 30 is joined to the heat exchanger 10 by the cold forming process. In the second step 200, to join the bracket 30 to the heat exchanger 10, the particulates are applied to the bracket 30 during the cold forming process in a first sub-step 210. The particulates form the weld joint 36 which, as shown in FIGS. 2-9, is formed along edges or internal features such as apertures or slots of the bracket 30. In a second sub-step 220, the bracket 30 is then attached to the outer surface 20 of the heat exchanger 10. Although, it is understood, the particulates can be applied to the outer surface 20 of the heat exchanger 10 first and then the bracket 30 can be attached to the outer surface 20 of the heat exchanger 10 after applying the particulates, if desired. Additionally, the particulates can be applied to both the heat exchanger 10 and the bracket 30 before attaching the bracket 30 to the heat exchanger 10, if desired.

The bracket 30 assembled to the heat exchanger 10 according to the present disclosure can be formed from materials, such as plastic, permitting the brackets 30 to have a more complex configuration with greater functionality while minimizing costs and a weight of the bracket 30. The brackets 30 of the present invention are not required to be assembled to the heat exchanger 10 prior to or during the brazing of the heat exchanger 10. Rather, the bracket 30 can be assembled to the heat exchanger 10 after the brazing of the heat exchanger 10.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A heat exchanger for a vehicle comprising:
a heat exchanger core configured to exchange heat between fluids;
a header in fluid communication with the heat exchanger; and
a bracket coupled to a the header by a cold forming process.

2. The heat exchanger of claim 1, wherein the cold forming process includes spraying particulates along a surface of one of the header and the bracket to form a weld joint.

3. The heat exchanger of claim 2, wherein the bracket includes a flange portion engaging the header, and wherein the flange portion is one of arcuate and planar.

4. The heat exchanger of claim 3, wherein the weld joint is formed along outer opposing side edges of the flange portion.

5. The heat exchanger of claim 3, wherein the bracket includes an aperture formed through the flange portion and wherein the weld joint is formed about the aperture formed through the flange portion.

6. The heat exchanger of claim 5, wherein the aperture is one of circular and ovular.

7. The heat exchanger of claim 3, wherein the bracket includes a structure supporting structure extending outwardly from the flange portion, and wherein the structure supporting structure includes an engagement feature configured to engage a component of the vehicle.

8. The heat exchanger of claim 7, wherein the engagement feature is one of a tooth, an aperture, and a receptacle, the receptacle having a plurality of apertures formed in the receptacle.

9. The heat exchanger of claim 7, wherein the bracket includes a secondary flange portion coupled to the structure supporting structure configured for coupling to a secondary component of the vehicle by the cold forming process.

10. The heat exchanger of claim 3, wherein the flange portion is planar and includes a first planar leg and a second planar leg, and wherein the weld joint is formed along outer opposing side edges of the first planar leg and the second planar leg.

11. The heat exchanger of claim 3, wherein the flange portion includes a first pair of flange portions and a second pair of flange portions, wherein the weld joint is formed along a portion of a perimeter of each of the first pair of flange portions and the second pair of flange portions.

12. The heat exchanger of claim 1, wherein the bracket is non-metallic.

13. The heat exchanger of claim 1, wherein the bracket is plastic.

14. The heat exchanger of claim 1, wherein the bracket is metallic.

15. A heat exchanger for a vehicle comprising:
a heat exchanger core and header assembly configured to exchange heat between fluids, the heat exchanger core and header assembly including an outer surface;
a bracket coupled to the outer surface of the heat exchanger core and header assembly by a cold forming process; and
a weld joint formed between the bracket and the outer surface of the heat exchanger core and header assembly by the cold forming process.

16. The heat exchanger of claim 15, wherein the bracket is plastic.

17. A method of assembling a heat exchanger and a bracket comprising the steps of:
assembling a heat exchanger core and a header to the heat exchanger core by a first process; and
coupling a bracket to an outer surface of the assembled heat exchanger core and the header by a second process after the first process, wherein the second process is a cold forming process.

18. The method of claim 17, wherein the first process is a brazing process.

19. The method of claim 17, wherein the step of coupling the bracket to the outer surface of the assembled heat exchanger core and the header includes spraying the outer surface of the assembled heat exchanger core and the header or the bracket with particulates.

20. The cold plate assembly of claim 17, wherein the bracket is plastic.
